(19) United States
(12) Patent Application Publication
(10) Pub. No.: US 2004/0251441 A1
(43) Pub. Date: Dec. 16, 2004

(54) Electromagnetically actuated valve, especially for hydraulic braking systems of motor vehicles

(76) Inventors: Holger Schmitt, Esslingen (DE); Massimiliano Ambrosi, Marbach (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/333,796

(22) PCT Filed: Jul. 26, 2001
(86) PCT No.: PCT/DE01/02823

(30) Foreign Application Priority Data
Jul. 27, 2000 (DE) 100 36 576.0

(51) Int. Cl. F16K 31/02

(52) U.S. Cl. 251/129.07

(57) ABSTRACT

A valve (10) has a valve body (16) with a longitudinal bore (17), a valve dome (18) connected to the valve body (16), an armature (19) received longitudinally movably in the valve dome (18), and a tappet (36) for transmitting an armature motion to a closing member (40) of a seat valve (41). The tappet (36) is guided with slight radial play over the entire length of the longitudinal bore (17) of the valve body (16) and is provided on its jacket side with at least two separate conduits (37). A valve chamber (31) of the valve (10) that contains the seat valve (41) communicates fluidically with the valve dome (18) through the conduits (37). Residual air in the valve dome (18) can be positively displaced through the conduits (37).

The valve (10) can be used in hydraulic brake systems of motor vehicles.

### PRIOR ART

The invention is based on an electromagnetically actuated valve as generically defined by the preamble to claim 1 .

One such valve is already known (German Patent Disclosure DE 44 45 221 A1), in which the tappet is provided on its outside with three longitudinally extending flat faces for carrying liquid into the valve dome, in order to generate an exertion of hydraulic force on the armature of the valve. Since the tappet is guided, toward the valve chamber, with slight radial play in the longitudinal bore of the valve body but toward the valve dome the radial play increases greatly and at the same time the cross section of the conduits in the tappet that are created by the flat faces decreases considerably, the split flows of liquid in the three conduits are reunited in the course of the longitudinal bore of the valve body. Air present in the valve dome is therefore removable only with difficulty. However, air in the valve makes it noisier in operation.

### ADVANTAGES OF THE INVENTION

The valve of the invention having the characteristics of claim 1 has the advantage over the prior art that liquid from the valve chamber can pass with relatively slight flow resistance through at least one conduit into the valve dome, where it can positively displace air that is present; this air can pass to the valve chamber through a different conduit and from there be diverted out of the valve. Since a plurality of separate conduits are available as flow courses and do not communicate with one another until the valve dome, the air is bled out quite effectively.

By the provisions recited in the dependent claims, advantageous refinements of and improvements to the valve defined by claim 1 are disclosed.

With the embodiment of the valve in accordance with claim 2, a conduction of the liquid flow into the conduits of the tappet is effectively reinforced in an advantageous way.

In claims 3 and 4, expedient provisions for the design of the tappet are disclosed.

The refinement of the invention disclosed in claim 5 promotes the bleeding of air from the valve dome through flow courses embodied in the armature.

The provision recited in claim 6, where the tappet is guided in the valve body with little play, assures that the closing member securely finds the valve seat of the seat valve even under unfavorable tolerance conditions.

### DRAWING

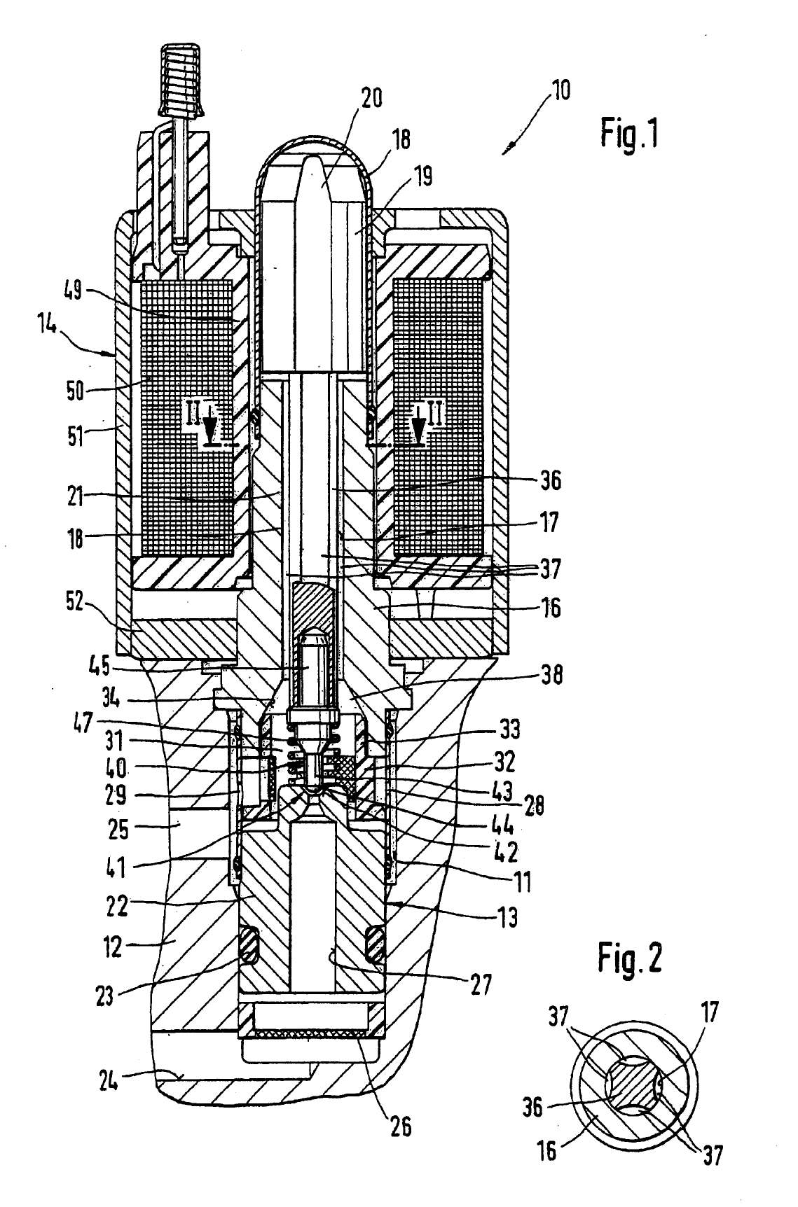

One exemplary embodiment of the invention is shown in simplified form in the drawing and explained in further detail in the ensuing description. FIG. 1 is a longitudinal section through an electromagnetically actuated valve; and FIG. 2 shows a cross section taken along the line II-II of FIG. 1 through a valve body and a tappet of the valve.

### DESCRIPTION OF THE EXEMPLARY EMBODIMENT

An electromagnetically actuated valve 10, shown in FIG. 1 of the drawing, for hydraulic brake systems of motor vehicles essentially comprises two component groups: a hydraulic part 13, secured in a stepped bore 11 of a valve block 12, and an electrical part 14, slipped onto the hydraulic part.

The hydraulic part 13 has a valve body 16 with a continuous longitudinal bore 17. On the end with the electrical part 14, a valve dome 18 is secured to the valve body 16. An armature 19 with longitudinally extending grooves 20 is received longitudinally movably in the valve dome 18.

A valve seat part 22 with a sealing ring 23 disposed on its circumference is received in the stepped bore 11 of the valve block 12. This sealing ring divides an inflow bore 24 of the valve block 12 from an outflow bore 25. A filter disk 26 is disposed in the stepped bore 11 on the side toward the inflow bore 24. The valve seat part 22, provided with a longitudinal bore 27, is connected to the valve body 16 by means of a sleeve 28. The sleeve 28 has a bore 29 on its jacket side.

The sleeve 28 surrounds a valve chamber 31 that extends between the valve body 16 and the valve seat part 22. A filter sleeve 32 is received in this valve chamber and engages a larger-diameter portion 33 of the longitudinal bore 17 of the valve body 16. This portion 33 of the bore is adjoined by a hollow-conical transition 34 to the smaller-diameter part of the longitudinal bore 17.

A pinlike tappet 36 is received in the longitudinal bore 17 of the valve body 16. This tappet extends from the armature 19 to the inside of the valve chamber 31. The tappet 36 is guided longitudinally displaceably with slight radial play over the entire length of the smaller-diameter part of the longitudinal bore 17. On its jacket side, the tappet 36 has four separate conduits 37, which extend along the tappet 36, beginning at the valve chamber 31, as far as the valve dome 18 (FIGS. 1 and 2). The conduits 37 are disposed at uniform intervals on the tappet 36 and are rounded in concave fashion in their cross section. Since the tappet 36 protrudes into the valve chamber 31, this chamber is in communication with the conduits 37 of the tappet in a streamlined way because of the hollow-conical transition 34, with a constriction 38 of wedge-shaped cross section oriented toward the tappet 36.

A closing member 40 of a seat valve 41 is located in the valve chamber 31, remote from the valve dome. It has a hollow-conical valve seat 42, embodied on the valve seat part 22, that communicates fluidically with the longitudinal bore 27 of the valve seat part 22. Toward the valve seat part 22, the closing member 40 has a smaller-diameter cylindrical portion 43, which changes over at a sharp edge into a ball segment 44 associated with the valve seat 42. Remote from the valve seat, the closing member 40 is provided with a tang 45, with which, extending coaxially to the tappet 36, it engages the inside of the tappet with great radial play.

Also received in the valve chamber 31 is a restoring spring 47, in the form of a helical compression spring, which in prestressed fashion engages the valve seat part 22 on one end and the closing member 40 on the other. Under the influence of the restoring spring 47, the closing member 40, tappet 36 and armature 19 are braced by nonpositive engagement on one another. As FIG. 1 shows, the seat valve 41 assumes its open position, in which the closing member 40, via the tappet 36, keeps the armature 19 in contact with the valve dome 18.

The electrical part 14 of the valve 10 essentially surrounds the valve body 16, with the valve dome 18 and armature 19, that protrudes from the valve block 12. The electrical part 14 comprises a coil 49 with an electric winding 50 that is enclosed by a magnetic-flux-conducting housing 51 with a yoke ring disk 52. In conjunction with the electrical part 14, the valve body 16 is at the same time the pole core of the valve 10.

The valve 10 can be actuated as a result of current being supplied to its electric winding 50, thus generating an exertion of magnetic force on the armature 19. The magnetic force causes a motion of the armature 19 toward the valve body 16. The armature motion is transmitted to the closing member 40 via the tappet 36. As a result, the seat valve 41 can be switched out of the open position, shown, to the closing position in which the ball segment 44 engages the valve seat 42; or, by means of how the current is controlled, it can be switched into arbitrary intermediate positions. When the seat valve 43 is open, the inflow bore 24 of the valve block 12 communicates with the outflow bore 25. Fluid can flow from the inflow bore 24 through the longitudinal bore 27 in the valve seat part 22, the valve seat 42, the valve chamber 31, the filter sleeve 32, and the bore 29 in the sleeve 28 to the outflow bore 25. The valve dome 18 fluidically communicates with the fluid-filled valve chamber 31 through the conduits 37 of the tappet 36.

The first time the brake system is filled, there can be air in the valve dome 18. The air is positively displaced out of the valve dome 18 in the following way: When the seat valve 41 is opening from the closing position, streams of fluid emerging from the valve seat 42 get into the constriction 38, opposite the valve seat 42, of the valve chamber 31 and from there reach the valve dome 22, through at least one conduit 37 and at least one groove 20 in the armature 19. In the valve dome, the fluid positively displaces the air that is present and entrains it through another conduit 37 into the valve chamber 31, from which the fluid-air mixture is carried out of the valve 10 through the outflow bore 25.

1-6 cancel

7. An electromagnetically actuated valve (10), in particular for hydraulic brake systems of motor vehicles, comprising a valve body (16), a valve dome (18) connected to the valve body (16), an armature (19) received longitudinally movably in the valve dome (18), a longitudinal bore (17) in the valve body (16), and a tappet (36), longitudinally movably guided in the longitudinal bore (17), for transmitting an armature motion to a closing member (40) of a seat valve (41) in a valve chamber (31) remote from the valve dome, to which chamber liquid flowing from a valve seat (42) of the seat valve (41) can be delivered and carried through at least one conduit (37) of the tappet (36) into the valve dome (18), and on its jacket side the tappet (36) having at least two conduits (37), separate from one another, which extend along the tappet (36) from the valve chamber (31) to the valve dome (18),
the tappet (36) being guided with slight radial play over the entire length of the longitudinal bore (17) of the valve body (16) and
a constriction (38) in the valve chamber (31), the constriction being of wedge-shaped cross section toward the tappet (36), whereby the valve chamber (31) changes over, on its side away from the valve seat (42), into the conduits (37) in the tappet.

8. The valve of claim 7, wherein the conduits (37) are distributed at uniform intervals on the tappet (36).

9. The valve of claim 8, wherein the conduits (37) are of rounded concave cross section.

10. The valve of claim 7, wherein the armature (19) is provided with longitudinally extending grooves (20).

11. The valve of claim 7, wherein the closing member (40), includes a tang (45) extending coaxially to the tappet (36), and is received with great radial play in the tappet (36).
